(19) United States
(12) Patent Application Publication
(10) Pub. No.: US 2011/0289941 A1
(43) Pub. Date: Dec. 1, 2011

(54) BRAYTON CYCLE REGASIFICATION OF LIQUIEFIED NATURAL GAS

(75) Inventors: Miguel Angel Gonzalez Salazar, Munich (DE); Matthias Finkenrath, Garching b. Muenchen (DE); Johannes Eckstein, Ismaning (DE); Clarissa Sara Katharina Belloni, Oxford (GB)

(73) Assignee: GENERAL ELECTRIC COMPANY, SCHENECTADY, NY (US)

(21) Appl. No.: 12/790,333

(22) Filed: May 28, 2010

(51) Int. Cl. F17C 9/02; F02C 1/04

(52) U.S. Cl. 62/50.2; 60/650; 60/682

(57) ABSTRACT

A power plant including an apparatus for regasification of liquefied natural gas (LNG) is provided. The apparatus includes a compressor configured to pressurize a working fluid and a heat recovery system configured to provide heat to a working fluid. A turbine is configured to generate work utilizing the heated working fluid. One or more heat exchangers are configured to transfer heat from the working fluid to a first stage liquefied natural gas at a first pressure and at least one of a second stage liquefied natural gas at a second pressure, and a compressed working fluid.

### BACKGROUND

The subject matter disclosed herein relates generally to regasification of Liquefied Natural Gas (LNG), and more specifically to methods and systems utilizing Brayton cycles for regasification of LNG.

Conventionally, natural gas is transported in a liquefied form, that is, as LNG, which is subsequently regasified for distribution as pipeline natural gas, or for combustion use. LNG is typically transported at a temperature of about 160 degrees Celsius below zero, at a pressure of about 1 to 2 bar, and needs to be regasified before consumption or distribution to a temperature between about 10 degrees Celsius and about 30 degrees Celsius and a pressure between about 30 bar and about 250 bar.

Certain conventional techniques use seawater as a heat source for the regasification of LNG, which use, may under certain circumstances, have a negative impact on the environment. For example, cooling of sea water using a LNG regasification process involving seawater as a heat source may produce unforeseen effects on marine life and the ecosystem in the immediate neighborhood of the LNG regasification installation. Among other conventional techniques, natural gas may be combusted to produce the heat needed for the regasification of LNG, which increases the carbon footprint of the LNG use, for example, for power generation.

Accordingly, a need exists for an improved method and apparatus for regasification of LNG that overcome at least some of the abovementioned problems associated with conventional LNG regasification techniques.

### BRIEF DESCRIPTION

According to an embodiment of the present invention a power plant including an apparatus for regasification of liquefied natural gas (LNG) includes a compressor configured to pressurize a working fluid, a heat recovery system configured to provide heat to the working fluid, a turbine configured to generate work utilizing the working fluid, and one or more heat exchangers configured to transfer heat from the working fluid. The heat exchanger is configured to transfer heat to a first stage liquefied natural gas at a first pressure, and at least one of a second stage liquefied natural gas at a second pressure and the compressed working fluid.

According to another embodiment of the present invention, a method for regasification of liquefied natural gas in a LNG power generation plant includes recovering heat from a topping cycle of the power generation plant and heating a working fluid of a bottoming cycle of the power generation plant to provide a heated working fluid. At least a portion of the energy of the heated working fluid is released to generate work. Heat from the working fluid after generating work is transferred to a first stage liquefied natural gas at a first pressure, and at least one of a second stage liquefied natural gas at a second pressure and a compressed working fluid.

According to another embodiment of the present invention, a method for retrofitting an apparatus for regasification of liquefied natural gas in a LNG power generation plant includes providing one or more heat exchangers configured to transfer heat from a working fluid to a first stage liquefied natural gas at a first pressure and at least one of a second stage liquefied natural gas at a second pressure and a compressed working fluid. At least one of a first stage LNG pump configured to provide the first stage liquefied natural gas at the first pressure, and at least one second stage LNG pump configured to provide a second stage liquefied natural gas at the second pressure is also provided. The one or more heat exchangers, the first stage LNG pump, and the second stage LNG pump form a part of a modified bottoming Brayton cycle of the LNG power generation plant.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram illustrating a topping cycle and a bottoming Brayton cycle with two-stage LNG gasification according to an embodiment of the present invention.

FIG. 2 is a Temperature vs. Entropy chart illustrating an integrated cascaded Brayton cycle with two pressure levels of LNG regasification, according to an embodiment of the invention.

FIG. 3 is a schematic diagram illustrating a topping cycle and a bottoming Brayton cycle with two-stage LNG gasification according to another embodiment of the present invention.

FIG. 4 is a schematic diagram illustrating a topping cycle and a recuperated bottoming Brayton cycle with single-stage LNG gasification according to another embodiment of the present invention.

FIG. 5 is a schematic diagram illustrating a topping cycle and a hybrid recuperated bottoming Brayton cycle with two-stage LNG gasification according to another embodiment of the present invention.

### DETAILED DESCRIPTION

As used herein, an element or function recited in the singular and proceeded with the word “a” or “an” should be understood as not excluding plural said elements or functions, unless such exclusion is explicitly recited. Furthermore, references to “one embodiment” of the claimed invention should not be interpreted as excluding the existence of additional embodiments that also incorporate the recited features.

As noted, in one embodiment, the present invention provides a power plant including an apparatus for regasification of liquefied natural gas (LNG), the apparatus comprising (a) a compressor configured to pressurize a working fluid; (b) a heat recovery system configured to provide heat to the working fluid; (c) a turbine configured to generate work utilizing the working fluid; and (d) one or more heat exchangers configured to transfer heat from the working fluid to a first stage liquefied natural gas at a first pressure, and at least one of a second stage liquefied natural gas at a second pressure and a compressed working fluid.

In various embodiments, the power plant comprises a first stage LNG pump which may be used to provide a first stage liquefied natural gas at the first pressure, and a second stage LNG pump to provide the second stage liquefied natural gas at the second pressure.

A working fluid is used to capture heat generated by the power plant and transfer it in stages to the LNG being regasified. In various embodiments, the working fluid is heated in a heat recovery system configured to provide heat to the working fluid. In one embodiment, the working fluid is heated in the heat recovery system to a temperature between about 300° C. and about 700° C. In one embodiment, the heat recovery system is configured to extract heat from the hot exhaust gases produced by a power generation turbine. In an alternate embodiment, the heat recovery system is configured to extract heat from an external thermal cycle. In one embodiment, the external thermal cycle is a topping cycle of a LNG power generation plant.

In various embodiments, transfer of heat from the working fluid to the LNG is conducted in a heat exchanger. In one embodiment, the heat exchanger is configured to provide a heated first stage liquefied natural gas at a temperature between about −140° C. and about −110° C.

In one embodiment, the heat exchanger is configured to receive a second stage liquefied natural gas at a temperature between about −130° C. and about −100° C. and a pressure between about 50 bar and about 700 bar. In one embodiment, the heat exchanger is configured to provide a heated second stage liquefied natural gas at a temperature between about 0° C. and about 40° C.

In one embodiment, at least two heat exchangers, a first heat exchanger and a second heat exchanger are present. In one such embodiment, the first heat exchanger is configured to provide a heated first stage liquefied natural gas, and the second heat exchanger is configured to provide a heated second stage liquefied natural gas.

In one embodiment, the heat exchanger is configured to transfer heat to the second stage liquefied natural gas and the compressed working fluid. In one embodiment, the compressed working fluid is delivered to the heat exchanger at a temperature between about −30° C. and about 50° C. and a pressure between about 100 bar and about 200 bar. Under such circumstances the heat exchanger may be said to be configured to receive the compressed working fluid at a temperature between about −30° C. and about 50° C. and a pressure between about 100 bar and about 200 bar.

In one embodiment, the present invention provides a method for regasification of liquefied natural gas in a LNG power generation plant, the method comprising: (a) recovering heat from a topping cycle of the power generation plant and heating a working fluid of a bottoming cycle of the power generation plant to provide a heated working fluid; (b) releasing at least a portion of the energy contained in the heated working fluid to generate work; and (c) transferring heat from the working fluid after generating work to a first stage liquefied natural gas at a first pressure, and at least one of a second stage liquefied natural gas at a second pressure and a compressed working fluid.

In one embodiment, the method employs a working fluid selected from the group consisting of argon, helium, carbon dioxide, and nitrogen. In an alternate embodiment, the method employs a working fluid comprising at least one of argon, helium, carbon dioxide, and nitrogen. In one embodiment, the working fluid is nitrogen.

In one embodiment, the working fluid is heated in a heat recovery system associated with the topping cycle of the power generation plant to temperature in a range from about 300° C. to about 700° C. In an alternate embodiment, the working fluid is heated in a heat recovery system associated with the topping cycle of the power generation plant to temperature in a range from about 350° C. to about 650° C. In yet another embodiment, the working fluid is heated in a heat recovery system associated with the topping cycle of the power generation plant to temperature in a range from about 400° C. to about 600° C.

In one embodiment of the method of the present invention, the first stage liquefied natural gas has a temperature between about −160° C. and about −140° C. and a pressure of from about 1 bar to about 50 bar. In an alternate embodiment, the first stage liquefied natural gas has a temperature between about −160° C. and about −140° C. and a pressure of from about 2 bar to about 15 bar.

In one embodiment of the method of the present invention, the first stage liquefied natural gas is introduced into a heat exchanger where it absorbs heat from the working fluid to provide on emerging from the heat exchanger a heated first stage liquefied natural gas having a temperature between about −140° C. and about −110° C.

In one embodiment of the method of the present invention, the second stage liquefied natural gas is introduced into a heat exchanger at a temperature between about −130° C. and about −100° C. and a pressure between about 50 bar and about 700 bar. The second stage liquefied natural gas absorbs heat from the working fluid being introduced into the heat exchanger to provide on emerging from the heat exchanger a heated second stage liquefied natural gas having a temperature between about 0° C. and about 40° C.

In one embodiment of the method of the present invention, heat is transferred from the working fluid to the first stage liquefied natural gas in a first heat exchanger, and from the working fluid to the second stage liquefied natural gas in a second heat exchanger, to provide a heated first stage liquefied natural gas and a heated second stage liquefied natural gas.

In one embodiment of the method of the present invention, a single heat exchanger is used to transfer heat from the working fluid to the first stage liquefied natural gas and the second stage liquefied natural gas. Thus, heat is transferred from the working fluid to the first stage liquefied natural gas in a first heat exchanger, and from the working fluid to the second stage liquefied natural gas in the same first heat exchanger to provide a heated first stage liquefied natural gas and a heated second stage liquefied natural gas.

As noted, in one embodiment of the method of the present invention, heat is recovered from a topping cycle of a power generation plant and is used to heat a working fluid of a bottoming cycle of the power generation plant to provide a heated working fluid. The working fluid may be heated in a heat recovery system integrated into the power generation plant. Typically, the working fluid is introduced into a heat exchanger at a point downstream of an energy extraction device, such as a turbine which uses a portion of the energy contained in the heated working fluid to generate work. In one embodiment, the working fluid is introduced into a heat exchanger at a point downstream of an energy extraction device and transfers heat to the first stage liquefied natural gas to provide a heated first stage liquefied natural gas. The working fluid emerging from the heat exchanger may thereafter be subjected to a compression step to provide a compressed working fluid. Additional heat may be extracted from this compressed working fluid by passing the compressed working fluid through one or more heat exchangers in contact with either or both of the first stage liquefied natural gas and the second stage liquefied natural gas. In one embodiment, the temperature of the compressed working fluid is sufficiently low such that heat is transferred to the compressed working fluid as it passes through the heat exchanger. Under such circumstances, the heat exchanger is said to be configured to transfer heat to the compressed working fluid. In one embodiment, the compressed working fluid is introduced into the heat exchanger at a temperature between about −30° C. and about 50° C. and a pressure between about 100 bar and about 200 bar.

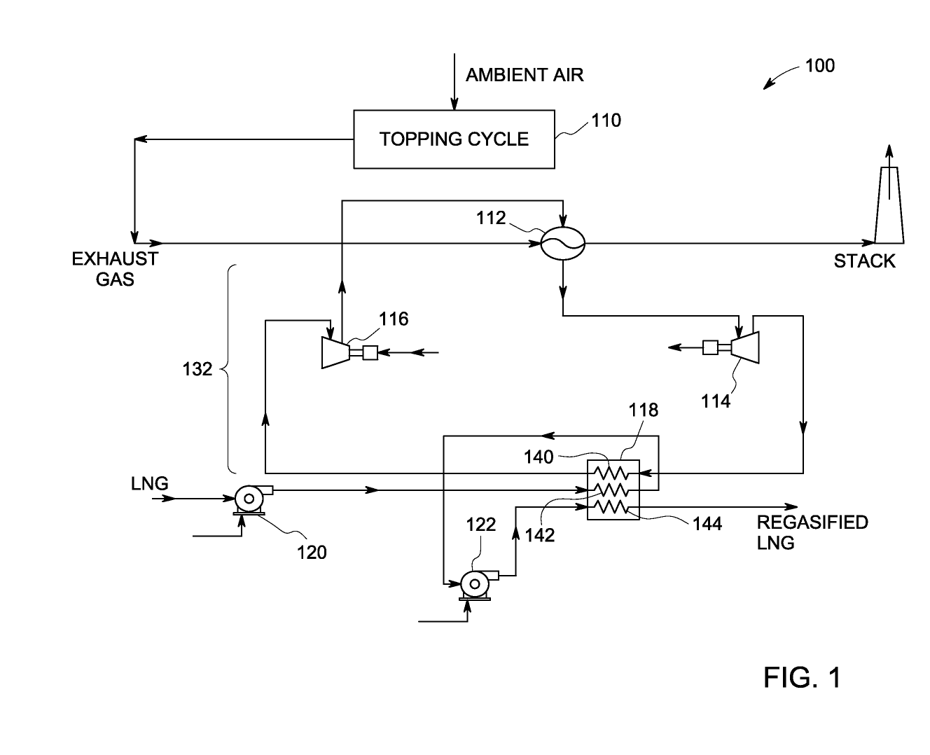

FIG. 1 illustrates a power generation plant, or a system, 100 including an apparatus for regasification of liquefied natural gas (LNG), according to an embodiment of the present invention. The system 100 comprises a topping cycle 110, which uses fuel (e.g. regasified LNG) to combust with an oxidant (e.g. ambient air) to generate energy and a hot exhaust, among others. According to several embodiments of the invention provided herein, the topping cycle 110 is an open Brayton cycle. The hot exhaust gases from the topping cycle 110 are channeled through a heat recovery system 112 configured to absorb heat from the hot exhaust, and provide it to a working fluid of a bottoming Brayton cycle 132. The system 100 provides both for electric power generation, and efficient regasification of liquefied natural gas at two pressure levels. The system 100 comprises two cascaded Brayton cycles, that is, the topping Brayton cycle 110 and the bottoming closed Brayton cycle 132. It will be appreciated by those of ordinary skill in the art that the topping cycle 100 is shown as a Brayton cycle merely by way of illustration and not by way of limitation. In the embodiment of the present invention illustrated in FIG. 1, the topping Brayton cycle 110 is based on an open simple gas turbine cycle, and the bottoming cycle 132 is based on a closed simple Brayton cycle working with a suitable working fluid. In the embodiment illustrated in FIG. 1, the bottoming Brayton cycle 132 provides for two stage LNG regasification.

The bottoming cycle 132 includes a turbine 114 for generating work from the working fluid, a heat exchanger 118 to transfer heat from the working fluid to LNG for regasification, and a compressor 116 to pressurize the working fluid. In the illustrated embodiments, the working fluid of the bottoming cycle is any suitable fluid which is relatively inert under normal circumstances, and may be selected to mitigate fire, explosion, or other safety hazards. Suitable working fluids include but are not limited to generally inert gases such as, argon, helium, nitrogen, carbon dioxide among others. While in the embodiments discussed herein, nitrogen is the working fluid intended, those skilled in the art will readily appreciate that alternate working fluids generally known in the art are usable within the scope and spirit of the present invention. The system 100 further comprises a first stage LNG pump for providing a first stage liquefied natural gas to the heat exchanger 118, and a second stage LNG pump for providing a second stage liquefied natural gas to the heat exchanger 118. As illustrated by FIG. 1, the heat exchanger 118 is a 3-stream heat exchanger configured to exchange heat between the working fluid and the first and the second stage liquefied natural gas. The 3-stream heat exchanger 118 includes a heated working fluid stream 140, a first stage LNG stream 142 and a second stage LNG stream 144.

Still referring to the embodiment illustrated in FIG. 1, in operation, the heat recovery system 112 heats or energizes the working fluid before the working fluid enters the turbine 114. The turbine 114 generates work (utilized for power generation, for example) and releases the working fluid, which has lost at least some energy to the turbine, and the working fluid then enters the heat exchanger 118 as heated working fluid stream 140. The heat exchanger 118 regasifies the liquefied natural gas in two stages. In this example, the liquefied natural gas is regasified and the regasified natural gas may be provided to a pipeline or another installation requiring natural gas in a gaseous state. In one embodiment, the regasified natural gas is provided at a pressure between about 80 bar and about 250 bar. In an alternate embodiment, the regasified natural gas is provided at a pressure between about 50 bar and about 700 bar. In one embodiment, the regasified natural gas is provided at a temperature between about 10° C. and about 30° C. In the first regasification stage, the first stage LNG pump 120 pressurizes the first stage liquefied natural gas to between about 1 bar and about 50 bar at a temperature between about −160° C. and about −140° C. The pressurized LNG enters the heat exchanger 118 and is shown in FIG. 1 as first stage LNG stream 142. The first stage liquefied natural gas absorbs heat from the working fluid, and exits the heat exchanger 118 in a liquid state, at a temperature between about −140° C. and about −110° C. Thereafter, in the second stage, the second stage LNG pump 122 pressurizes the second stage liquefied natural gas to a vaporization pressure of between about 50 bar and about 700 bar (depending on the desired delivery pressure), and at a temperature between about −130° C. and about −100° C. . The second stage liquefied natural gas enters the heat exchanger 118 and is shown in FIG. 1 as second stage LNG stream 144. The second stage liquefied natural gas absorbs heat from the working fluid, and exits the heat exchanger 118 in a substantially fully vaporized state, at a pressure typically between about 50 bar and about 700 bar, and a temperature between about 0° C. and 40° C. Accordingly, the liquefied natural gas is regasified by use of two-stage pumping, at higher efficiencies compared to a 2-cascaded Brayton cycle with single-stage regasification, for example.

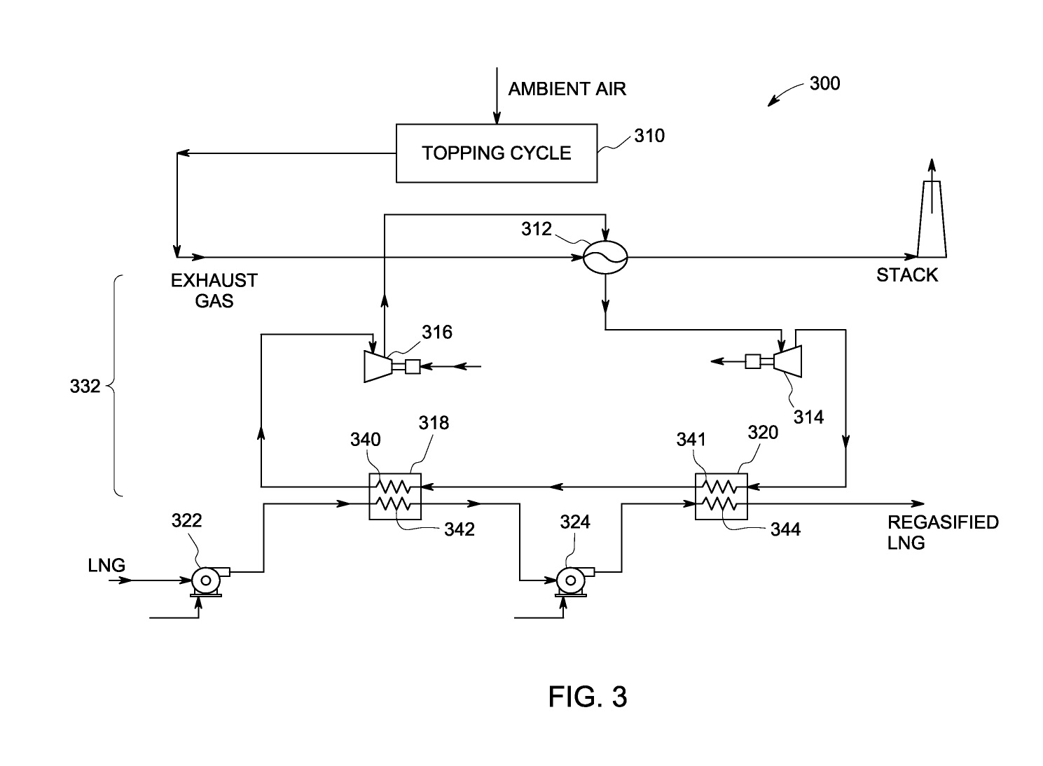

In summary, the 3-stream heat exchanger 118 operates by having the first stage liquefied natural gas pumped to an intermediate pressure (advantageously as low as possible) and sent to the first stage LNG stream 142 at a very low temperature. The first stage liquefied natural gas absorbs heat from the working fluid and exits the first stage LNG stream 142 in a liquid state. This liquefied natural gas emerging from the heat exchanger is then pumped to a higher pressure (second stage), and is reintroduced into the heat exchanger 118 as the second stage LNG stream 144 to be fully vaporized by a second thermal contact with the working fluid which has a relatively high temperature (around 50-250° C. as the working fluid emerges from the turbine) relative to the liquefied natural gas being treated. However, those skilled in the art will appreciate that the concepts described herein with respect to the various illustrations are not restricted to a 3-stream heat exchanger such as 118, and include other variations such as those will occur readily to those skilled in the art. For example, according to an embodiment (further described with respect to FIG. 3) two separate heat exchangers may be utilized for regasifying LNG using the method provided by the present invention.

It has been discovered that decreasing the minimum temperature of the working fluid employed has a beneficial effect on the overall efficiency of the LNG liquefication process and raises the electrical efficiency of the bottoming cycle. In an embodiment of the present invention configured as illustrated by FIG. 1, the temperature of the first stage liquefied natural gas entering the heat exchanger 118 is kept as low as possible and avoids a sharp increase in LNG pressure (and temperature), features characteristic of single-stage regasification systems. Advantageously, the liquefied natural gas is regasified (and pumped) in two stages instead of one. The pumping (and therefore pressurizing) of the liquefied natural gas in multiple stages, and enables better control the temperature of the liquefied natural gas presented to the heat exchanger 118 (as low as possible) through multiple stages, and advantageously provides an increase in the overall efficiency of the bottoming cycle and liquefication process as a whole.

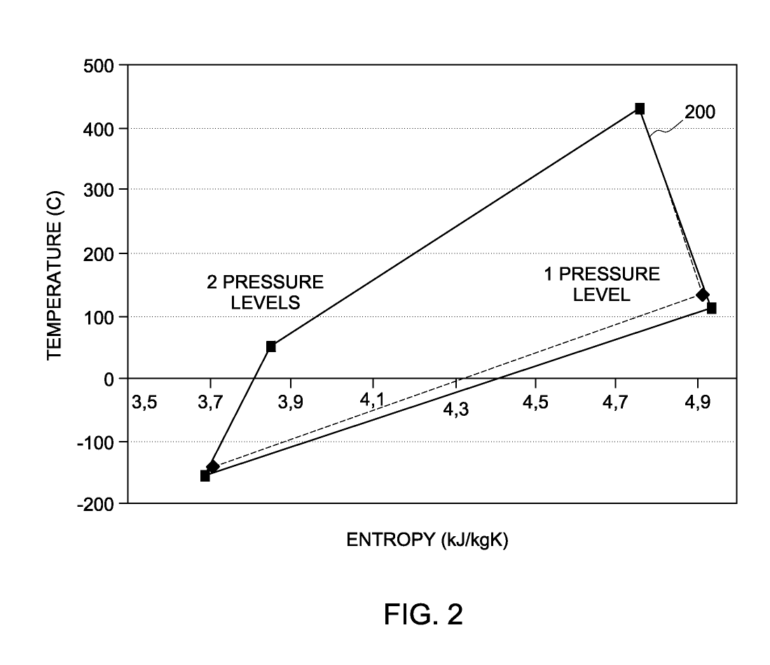

FIG. 2 is a plot 200 of temperature versus entropy for a cascaded nitrogen Brayton cycle (simulated) in which LNG regasification is carried out across two pressure stages, for example, as in the system 100 depicted in FIG. 1. In the simulation results depicted in plot 200, various assumptions were made for the purposes of the simulation. Thus, the efficiency of the topping cycle efficiency was assumed to be 42%, exhaust gas temperature was assumed to be 460° C., LNG temperature was assumed to be −162° C., and regasified LNG was assumed to be 10-15° C. and 200 bar. It was determined as a result of the simulation, and is inferable from the graph 200, that the overall efficiency is increased from 53.8% to 55% and a net power generation increase of about 2%, may be attained using the method of the present invention. The enhanced efficiency achieved is at least in part due to the efficient heat transfer from nitrogen (working fluid) to the liquefied natural gas. According to an example, since the available heat contained in exhaust gas of the topping cycle does not vary, and the characteristics of the working fluid entering and exiting heat recovery system 112 are the same as in the conventionally configurations used for regasifying LNG at a single pressure level, the working fluid mass flow of the bottoming cycle can remain invariable along with the design and characteristics of the heat recovery system 112. Accordingly, the various embodiments of the present invention can be easily configured, or retrofitted, into existing power plants and thereby improve the associated efficiency of the power plants.

FIG. 3 illustrates a power generation plant, or a system, 300 including an apparatus for regasification of liquefied natural gas (LNG), similar to the system 100, according to another embodiment of the present invention. The system 300 comprises a topping cycle 310, a heat recovery system 312 to recover heat from the topping cycle 310 and provide it to a working fluid of a bottoming cycle 332, a turbine 314, a compressor 316, a first heat exchanger 318 having a heated working fluid stream 340 and a first stage LNG stream 342, a second heat exchanger 320 having a heated working fluid stream 341 and a second stage LNG stream 344, a first stage LNG pump 322, and a second stage LNG pump 324. The first and the second heat exchangers 318, 320 are each 2-stream heat exchangers. Liquefied natural gas in a first stage is pumped to the first stage LNG stream 342 using the first stage LNG pump 322, at a pressure between about 1 bar and about 50 bar and a temperature between about −160° C. and about −140° C. The first stage liquefied natural gas exits the first heat exchanger 318 at temperature between about −140° C. and about −110° C. Thereafter, in the second stage, the liquefied natural gas is pumped at a pressure between about 50 bar and about 700 bar (depending on the required delivery pressure) and a temperature between about −130° C. and about −100° C. by second stage LNG pump 324 to the second heat exchanger 320 and passes through the second heat exchanger as stream 344. The second stage liquefied natural gas exits the second heat exchanger 320 at a pressure between about 50 bar and about 700 bar. In one embodiment, the second stage liquefied natural gas exits the second heat exchanger 320 at a pressure between about 80 bar and about 250 bar. The temperature of the natural gas exiting the second heat exchanger 320 is typically between about 0° C. and about 40° C.

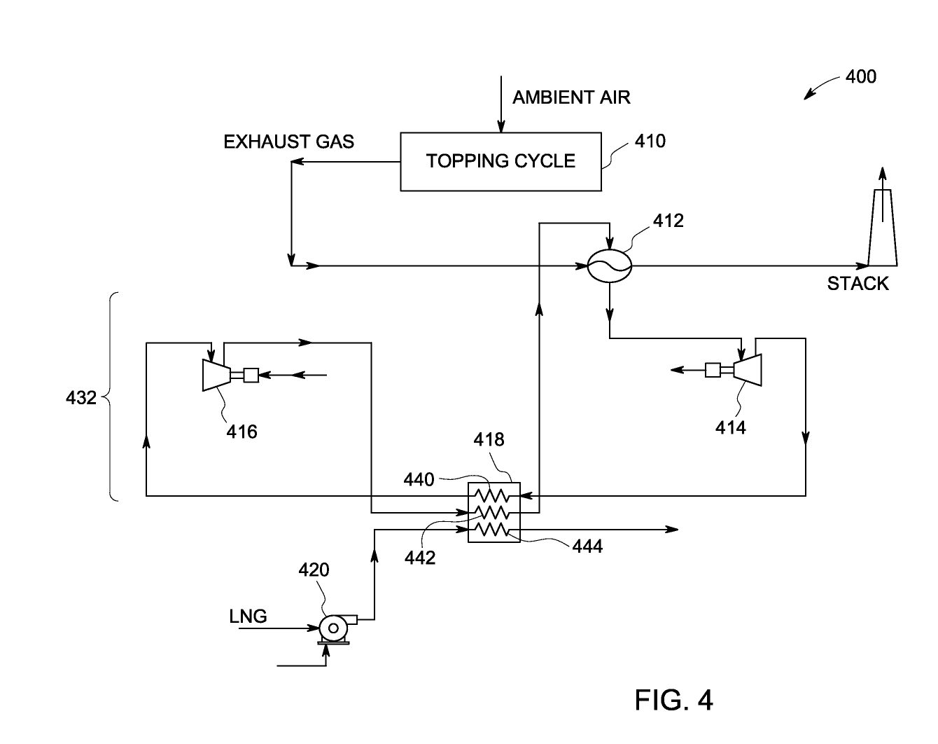

FIG. 4 illustrates a power generation plant, or a system, 400 including an apparatus for regasification of liquefied natural gas (LNG), according to another embodiment of the present invention. The system 400 comprises a topping cycle 410, a heat recovery system 412 to recover heat from the topping cycle and provide it to a working fluid of a bottoming cycle 432, a turbine 414, a compressor 416, a 3-stream heat exchanger 418, and a first stage LNG pump 420. The 3-stream heat exchanger 418 includes a heated working fluid stream 440, a first stage LNG stream 442, and a working fluid recuperation stream 444. The system 400 operates similarly to the system 100 of FIG. 1, for example, and additionally, the system 400 includes one-stage LNG regasification, and the working fluid exiting from the compressor 416 is communicated to the heat exchanger 418 for recuperation of the bottoming Brayton cycle 432. Accordingly, the bottoming Brayton cycle 432 includes 1-stage LNG regasification and a recuperation stage for the working fluid. The working fluid enters the heat exchanger 418 in the working fluid recuperation stream 444 at a pressure of about 100 to about 200 bar and a temperature of about −50° C. to about 50° C., absorbs heat from the heated working fluid stream 440, and exits the heat exchanger 418 at about the same pressure and at a temperature of about 50° C. to about 200° C. Liquefied natural gas in a first stage is pumped to the first stage LNG stream 442 using the first stage LNG pump 420, at about 1 to about 50 bar and at a temperature of about −160° C. to about −140° C. In the embodiment shown in FIG. 4 the first stage liquefied natural gas exits the first heat exchanger 418 at a temperature between about 0° C. and about 40° C.

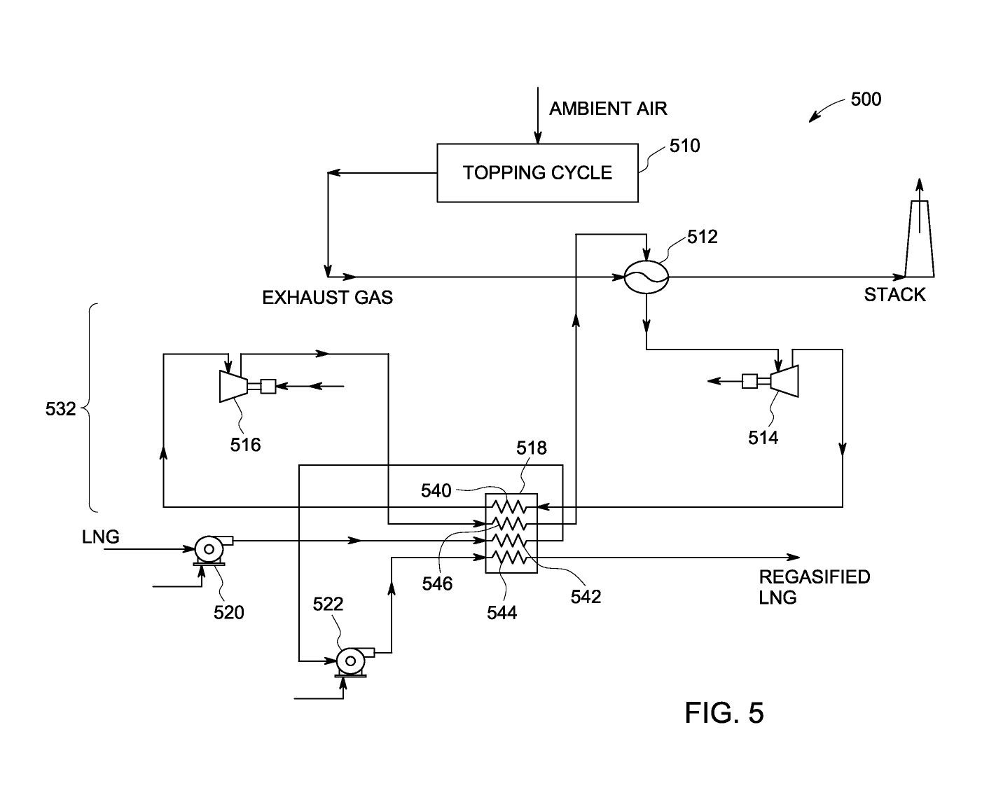

FIG. 5 illustrates a power generation plant, or a system, 500 including an apparatus for regasification of liquefied natural gas (LNG) according to another embodiment of the present invention. The system 500 comprises a topping cycle 510, a heat recovery system 512 to recover heat from the topping cycle 510 and provide it to a working fluid of a bottoming cycle 532, a turbine 514, a compressor 516, a 4-stream heat exchanger 518, a first stage LNG pump 520, and a second stage LNG pump 522. The 4-stream heat exchanger 518 includes a heated working fluid stream 540, a first stage LNG stream 542, a second stage LNG stream 544, and a working fluid recuperation stream 546. The system 500 operates similarly to the system 100 of FIG. 1, for example, and additionally, the working fluid that exits from the compressor 516 is communicated to the heat exchanger 518 for recuperation of the bottoming Brayton cycle 532. Accordingly, the bottoming Brayton cycle 532 includes 2-stage LNG regasification and a recuperation stage for the working fluid. The working fluid enters the heat exchanger 518 in the working fluid recuperation stream 546 at a pressure between about 100 bar and about 200 bar and a temperature between about −50° C. and 50° C., absorbs heat from the heated working fluid stream 540, and exits the heat exchanger 518 at a temperature between about 50° C. and about 200° C. Further, in the first regasification stage, the first stage LNG pump 520 pressurizes the first stage liquefied natural gas to between about 1 bar and about 50 bar, and a temperature between about −160° C. and −140° C. The first stage liquefied natural gas then enters the heat exchanger 518 as the first stage LNG stream 542. The first stage liquefied natural gas absorbs heat from the working fluid, and exits the heat exchanger 518 while still in a liquid state, at a temperature between about −140° C. and about −110° C. Thereafter, in the second stage, the second stage LNG pump 522 pressurizes the second stage liquefied natural gas to a vaporization pressure of between about 50 bar and about 700 bar, in one embodiment between about 80 bar and about 250 bar, (depending on the desired delivery pressure), and a temperature between about −130° C. and about −100° C. The second stage liquefied natural gas then enters the heat exchanger 518 as the second stage LNG stream 544. The second stage liquefied natural gas absorbs heat from the working fluid, and exits the heat exchanger 518 in a substantially fully vaporized state, at a pressure between about 50 bar and about 700 bar and at a temperature between about 0° C. and about 40° C.

In the recuperated Brayton cycle, after passing through the heat recovery system, the heated working fluid expands through a turbine, and is subsequently communicated to a 4-stream heat exchanger 518 that regasifies the liquefied natural gas in multiple stages, and simultaneously works as a recuperator to pre-heat the high-pressure working fluid exiting from the compressor 516. Since the nitrogen is pre-heated, lower temperatures are obtained at the compressor outlet, and therefore the compressor operates at lower pressure ratios in comparison to a non-recuperated Brayton cycle. Thus, higher electrical efficiencies may be achieved for recuperated Brayton cycles as compared to non-recuperated embodiments.

As discussed herein, many variations of the present invention are possible. For example, a variety of variations of the embodiment of the present invention illustrated by the system 100 of FIG. 1, have been discussed at length herein. In one embodiment, a recuperator used in the bottoming Brayton cycle may include either a 4 stream heat exchanger (as illustrated by the embodiment illustrated by system 500 of FIG. 5), or a 3-stream heat exchanger and a separate recuperator (not shown), or two separate LNG heat exchangers and a recuperator. In an alternate embodiment, the first and second stage LNG pumping can be provided by a single pump having two pressure stages. In one embodiment, each pressure stage is mounted on a common drive shaft of a two stage pump. These and other variations, permutations and combinations of the embodiments described herein will occur to those skilled in the art and in possession of this disclosure. Such variations, permutations and combinations of the embodiments described herein are included within the scope and spirit of the present invention.

Furthermore, it is appreciated that while various embodiments are illustrated herein with nitrogen as a working fluid for the bottoming Brayton cycle, working fluids other than nitrogen may also be used. As noted, any suitable working fluid may be employed in the practice of the present invention. Typically, the working fluid is either inert or non-reactive with respect to the power plant environment. Suitable working fluids include, for example, argon, helium, carbon dioxide, and mixtures thereof. Depending upon the specific working fluid used, the various temperature and pressure ranges may vary accordingly, as will occur readily to those skilled in the art and in possession of this disclosure.

Embodiments of the present invention provide a number of advantages over known embodiments. For example, by pumping the LNG at two different pressure levels it is possible to have a very low associated increase of LNG temperature in the first compression stage. Further, the minimum useful temperature of the working fluid is decreased. Furthermore, the electrical efficiency of the bottoming cycle in comparison to a configuration regasifying LNG at one pressure level is significantly increased. In various embodiments, the flexibility of the system to fulfill the regasified LNG requirements for delivery/storage is increased, since very high LNG vaporization pressures can be achieved. Furthermore, pumping can be performed using a single pump with multiple pressure stages. Advantageously, the various embodiments disclosed herein can be easily retrofitted into existing power plants. The specific components of existing power plants can be suitably modified or replaced to provide power plants consistent with the various embodiments described herein. Further, the conversion of the LNG from its liquid state to a gaseous state can be achieved with the same or greater reliability as in simple cascaded configurations, since in some embodiments no additional equipment may be required. Finally, the volume of three stream heat exchanger may increase in comparison with a comparable two stream heat exchanger, and therefore a higher specific power per unit of volume may result. Lower CO₂ emissions per unit of electricity generated per unit of fuel consumed may achieved, since a higher electrical efficiency and a higher power output (relative to comparable known systems) may be achieved using embodiments of the present invention.

Unless defined otherwise, technical and scientific terms used herein have the same meaning as is commonly understood by one of skill in the art to which this invention belongs. The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not limited to any one position or spatial orientation. If ranges are disclosed, the endpoints of all ranges directed to the same component or property are inclusive and independently combinable (e.g., ranges of “up to about 25 wt. %, or, more specifically, about 5 wt. % to about 20 wt. %,” is inclusive of the endpoints and all intermediate values of the ranges of “about 5 wt. % to about 25 wt. %,” etc.). As a further example, the temperature denoted by the expression “between about −130° C. and about −100° C.” should be interpreted to include each the named temperatures −130° C. and −100° C. The modifier “about” used in connection with a quantity is inclusive of the stated value and has the meaning dictated by the context (e.g., includes the degree of error associated with measurement of the particular quantity).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A power plant including an apparatus for regasification of liquefied natural gas (LNG), comprising:
a compressor configured to pressurize a working fluid;
a heat recovery system configured to provide heat to the working fluid;
a turbine configured to generate work utilizing the working fluid; and
one or more heat exchangers configured to transfer heat from the working fluid to a first stage liquefied natural gas at a first pressure, and at least one of a second stage liquefied natural gas at a second pressure and a compressed working fluid.

2. The power plant of claim 1 further comprising:
at least one of a first stage LNG pump to provide the first stage liquefied natural gas at the first pressure, and a second stage LNG pump to provide the second stage liquefied natural gas at the second pressure.

3. The power plant of claim 1, wherein the working fluid comprises at least one of argon, helium, carbon dioxide, and nitrogen.

4. The power plant of claim 1, wherein the heat recovery system is configured to heat the working fluid to a temperature between about 300° C. and about 700° C.

5. The power plant of claim 1, wherein the heat exchanger is configured to receive a first stage liquefied natural gas at a temperature between about −160° C. and about −140° C. and a pressure of from about 1 bar to about 50 bar.

6. The power plant of claim 1, wherein the heat exchanger is configured to provide a heated first stage liquefied natural gas at a temperature between about −140° C. and about −110° C.

7. The power plant of claim 1, wherein the heat exchanger is configured to receive the second stage liquefied natural gas at a temperature between about −130° C. and about −100° C. and a pressure between about 50 bar and about 700 bar.

8. The power plant of claim 1, wherein the heat exchanger is configured to provide a heated second stage liquefied natural gas at a temperature between about 0° C. and about 40° C.

9. The power plant of claim 1, comprising a first heat exchanger and a second heat exchanger, wherein the first heat exchanger is configured to provide a heated first stage liquefied natural gas, and the second heat exchanger is configured to provide a heated second stage liquefied natural gas.

10. The power plant of claim 1, comprising a heat exchanger configured to transfer heat to the second stage liquefied natural gas and the compressed working fluid.

11. The power plant of claim 10, wherein the heat exchanger is configured to receive the compressed working fluid at a temperature between about −30° C. and about 50° C. and a pressure between about 100 bar and about 200 bar.

12. The power plant of claim 1, wherein the heat recovery system is configured to extract heat from an external thermal cycle.

13. The power plant of claim 13, wherein the external thermal cycle is a topping cycle of a LNG power generation plant.

14. A method for regasification of liquefied natural gas in a LNG power generation plant, the method comprising:
recovering heat from a topping cycle of the power generation plant and heating a working fluid of a bottoming cycle of the power generation plant to provide a heated working fluid;
releasing at least a portion of the energy contained in the heated working fluid to generate work; and
transferring heat from the working fluid after generating work to a first stage liquefied natural gas at a first pressure, and at least one of a second stage liquefied natural gas at a second pressure and a compressed working fluid.

15. The method according to claim 14, wherein the working fluid comprises at least one of argon, helium, carbon dioxide, and nitrogen.

16. The method according to claim 14, wherein the heated working fluid has a temperature between about 300° C. and about 700° C.

17. The method according to claim 14, wherein the first stage liquefied natural gas has a temperature between about −160° C. and about −140° C. and a pressure of from about 1 bar to about 50 bar.

18. The method according to claim 14, wherein transferring heat between the working fluid and the first stage liquefied natural gas is conducted in a heat exchanger and provides a heated first stage liquefied natural gas having a temperature between about −140° C. and about −110° C.

19. The method according to claim 14 further comprising introducing the second stage liquefied natural gas into a heat exchanger at a temperature between about −130° C. and about −100° C. and a pressure between about 50 bar and about 700 bar to provide a heated second stage liquefied natural gas at a temperature between about 0° C. and about 40° C.

20. The method according to claim 14, comprising transferring heat from the working fluid to the first stage liquefied natural gas in a first heat exchanger, and transferring heat from the working fluid to the second stage liquefied natural gas in a second heat exchanger.

21. The method according to claim 14, comprising transferring heat from the working fluid to the first stage liquefied natural gas and to the second stage liquefied natural gas, said transferring being conducted in a first heat exchanger, to provide a heated first stage liquefied natural gas and a heated second stage liquefied natural gas.

22. The method according to claim 21, wherein the heat exchanger is configured to transfer heat to the compressed working fluid.

23. The method according to claim 21, wherein the compressed working fluid is introduced into the heat exchanger at a temperature between about −30° C. and about 50° C. and a pressure between about 100 bar and about 200 bar.

24. A method for retrofitting an apparatus for regasification of liquefied natural gas in a LNG power generation plant, the method comprising:
providing one or more heat exchangers configured to transfer heat from a working fluid to a first stage liquefied natural gas at a first pressure and at least one of a second stage liquefied natural gas at a second pressure and a compressed working fluid;
providing at least one of a first stage LNG pump configured to provide the first stage liquefied natural gas at the first pressure; and
providing at least one second stage LNG pump for configured to provide the second stage liquefied natural gas at the second pressure;
wherein the one or more heat exchangers, the first stage LNG pump, and the second stage LNG pump form a part of a modified bottoming Brayton cycle of the LNG power generation plant.
